(19) United States
(12) Patent Application Publication
(10) Pub. No.: US 2026/0292326 A1
(43) Pub. Date: Sep. 24, 2026

(54) APPARATUS AND METHOD FOR PROCESSING USER INTERFACE IN IMAGE

(71) Applicants: Hyundai Motor Company, Seoul (KR); Kia Corporation, Seoul (KR)

(72) Inventors: Jong Min Oh, Hwaseong-si (KR); Ji A Lee, Hwaseong-si (KR); Sung Woo Kim, Hwaseong-si (KR)

(21) Appl. No.: 19/266,787

(22) Filed: Jul. 11, 2025

(30) Foreign Application Priority Data
Mar. 21, 2025 (KR) 10-2025-0036788

(51) Int. Cl. H04N 23/63; G06F 3/04845; G06F 3/04883

(52) U.S. Cl. CPC H04N 23/632; G06F 3/04845; G06F 3/04883

(57) ABSTRACT

Disclosed is a camera image processing technology capable of reconfiguring a user interface depending on a movement path of an object in an image, which includes a reception device that receives the image, a display device that displays the image, and a controller that processes a variable interface and a fixed interface among user interfaces in the image. The controller controls the display device to display the variable interface around an object in the image, when user interaction touching the object is checked, controls the display device to move and re-display the variable interface around the moved object, when the object in the image moves, and processes the variable interface not to overlap with the fixed interface, when the variable interface overlaps with the fixed interface as the object moves.

### CROSS-REFERENCE TO RELATED APPLICATIONS

This application claims the benefit of priority to Korean Patent Application No. 10-2025-0036788, filed in the Korean Intellectual Property Office on March 21, 2025, the entire contents of which are incorporated herein by reference.

### TECHNICAL FIELD

The present disclosure relates to an apparatus and a method for processing a user interface in an image, and more particularly, relates to a camera image processing technology capable of reconfiguring a user interface depending on a movement path of an object in an image.

### BACKGROUND

In general, a mobile device, such as a robot or a vehicle, may capture an external environment while moving via a mounted camera and may identify an object in the captured image via the captured image.

There are various user interfaces on a display screen on which such a camera streaming image is output. A user may call functions or may execute operations of functions, via manipulation of the user interface.

Herein, the user interface may include a fixed interface fixed at a specific position in the display screen and a variable interface which varies in position as an object in the image moves.

As an example, there may occur a case where the variable interface should be linked to movement of the object in the image to move as a camera view moves or should be out of a camera view region.

As such, there may occur a state in which the variable interface and the fixed interface overlap with each other while the variable interface moves as the camera view moves. There occurs a situation where the user is unable to manipulate an interface located on a rear layer, when the variable interface and the fixed interface overlap with each other.

Thus, in the future, there will be a need to develop an apparatus for processing a user interface in an image to remove an overlap phenomenon between a variable interface and a fixed interface and visually naturally improve perceived quality.

### SUMMARY

The present disclosure has been made to solve the above-mentioned problems occurring in the prior art while advantages achieved by the prior art are maintained intact.

An aspect of the present disclosure provides an apparatus and a method for processing a user interface in an image to predict an overlap between a variable interface and a fixed interface based on calculating coordinates of the variable interface which moves as an object in an image moves and process the variable interface not to overlap with the fixed interface, thus removing an overlap phenomenon between the variable interface and the fixed interface to improve user convenience and increasing intuition of manipulation to visually naturally improve perceived quality.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for processing a user interface in an image may include a reception device that receives the image, a display device that displays the image, and a controller that processes a variable interface and a fixed interface among user interfaces in the image. The controller may control the display device to display the variable interface around an object in the image, when user interaction touching the object is checked, may control the display device to move and re-display the variable interface around the moved object, when the object in the image moves, and may process the variable interface not to overlap with the fixed interface, when the variable interface overlaps with the fixed interface as the object moves.

In an embodiment, the apparatus may further include a calculation device that calculates display information of the user interface based on coordinate information of the object in the image and coordinate information of the touch. The controller may control the display device to display the variable interface around the object based on the calculated result of the calculation device.

In an embodiment, the controller may control the display device to display a combined interface in which the variable interface and the fixed interface are combined with each other, when processing the variable interface not to overlap, and may process the variable interface, such that the variable interface and the fixed interface do not overlap with each other.

In an embodiment, the controller may check whether there is a need to divide the combined interface as the object moves, after displaying the combined interface, may control the display device to divide and display the combined interface into the fixed interface and the variable interface, when there is the need to divide the combined interface, and may control the display device not to display the variable interface corresponding to the object, when the object is out of the image.

In an embodiment, the controller may select a position where the variable interface does not overlap with the fixed interface in a surrounding region of the object, when processing the variable interface not to overlap, may control the display device to move and display the variable interface from a current position to the selected position on the selected position, and may process the variable interface, such that the variable interface and the fixed interface do not overlap with each other.

In an embodiment, the controller may control the display device to remove the fixed interface from the image not to display the fixed interface at the time point when the variable interface starts to overlap with the fixed interface, when processing the variable interface not to overlap, and may process the variable interface, such that the variable interface and the fixed interface do not overlap with each other.

In an embodiment, the controller may control the display device not to display the variable interface corresponding to the object, when the object is out of the image, after removing the fixed interface, and may simultaneously re-display the removed fixed interface.

According to another aspect of the present disclosure, a user interface processing method of a user interface processing apparatus for processing a variable interface and a fixed interface among user interfaces in the image may include checking user interaction touching an object in the image, displaying the variable interface around the object in response to the user interaction, moving and re-displaying the variable interface around the moved object, when the object in the image moves, and checking whether the variable interface overlaps with the fixed interface as the object moves, and processing the variable interface not to overlap with the fixed interface, when the variable interface and the fixed interface overlap with each other.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for processing a user interface according to an embodiment of the present disclosure;

FIG. 2 is a block diagram illustrating a configuration of an apparatus for processing a user interface according to an embodiment of the present disclosure;

FIG. 3 is a drawing for describing an object and a fixed interface in an image according to an embodiment of the present disclosure;

FIG. 4 is a drawing for describing an object and a variable interface in an image according to an embodiment of the present disclosure;

FIG. 5A is a drawing for illustrating a screen displaying a variable interface around an object according to an embodiment of the present disclosure;

FIG. 5B is a drawing for illustrating a screen that re-displays the variable interface based on the movement of the object according to an embodiment of the present disclosure;

FIG. 5C is a drawing for illustrating a screen that updates size and position of the variable interface according to an embodiment of the present disclosure;

FIG. 6A is a drawing for illustrating a screen displaying a variable interface and a fixed interface in an image according to an embodiment of the present disclosure;

FIG. 6B is a drawing for describing an overlap between a variable interface and a fixed interface in an image according to an embodiment of the present disclosure;

FIG. 7 is a drawing for describing a process of determining a movement direction of a variable interface in an image according to an embodiment of the present disclosure;

FIG. 8 is a drawing for illustrating a quadrant coordinate system according to an embodiment of the present disclosure;

FIG. 9 is a drawing for describing a process of processing the variable interface not to overlap with the fixed interface according to an embodiment of the present disclosure;

FIG. 10 is a drawing for a drawing for describing a process of determining an overlap between a variable interface and a fixed interface in an image according to an embodiment of the present disclosure;

FIG. 11 is a drawing for illustrating a screen displaying a combined interface in an image according to an embodiment of the present disclosure;

FIG. 12 is a drawing for describing a process of determining division of a variable interface processed not to overlap and a fixed interface in an image according to an embodiment of the present disclosure;

FIG. 13 is a drawing for describing a process of calculating a masking area of an object according to an embodiment of the present disclosure;

FIG. 14 is a drawing for describing a process of processing a variable interface, when a portion of an object is out of an image, according to an embodiment of the present disclosure;

FIG. 15 is a drawing for describing a process of processing a variable interface and a fixed interface in an image not to overlap with each other according to another embodiment of the present disclosure;

FIG. 16 is a drawing for describing a process of processing a variable interface and a fixed interface in an image not to overlap with each other according to another embodiment of the present disclosure;

FIG. 17 is a flowchart for describing a method for processing a user interface in an image according to an embodiment of the present disclosure; and

FIGS. 18A and 18B are flowcharts for describing a method for processing a variable interface such that the variable interface and a fixed interface do not overlap with each other via a combined interface according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment of the present disclosure, terms such as first, second, “A”, “B”, (a), (b), and the like may be used. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

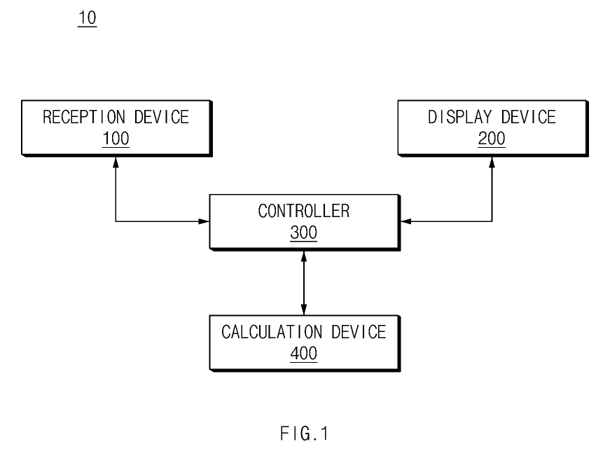

Hereinafter, embodiments of the present disclosure will be described in detail with reference to FIGS. 1 to 18B.

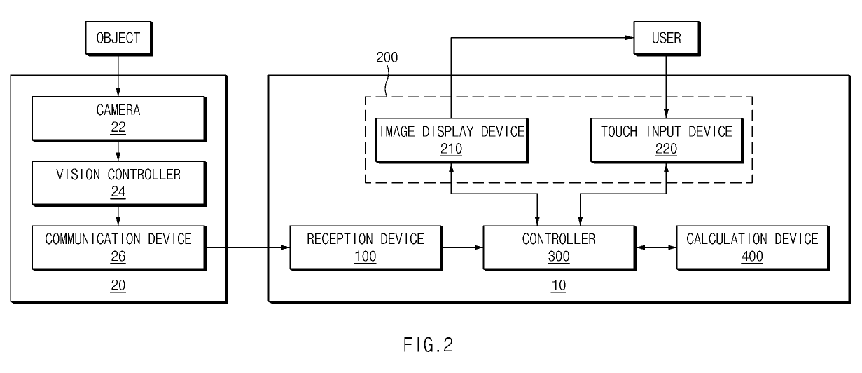

FIG. 1 is a block diagram illustrating a configuration of an apparatus for processing a user interface according to an embodiment of the present disclosure. FIG. 2 is a block diagram illustrating a configuration of an apparatus for processing a user interface according to another embodiment of the present disclosure.

As shown in FIGS. 1 and 2, an apparatus 10 for processing a user interface in the present disclosure may receive an image from a mobile device 20, including a vehicle, a robot, and the like, and may process a variable interface and a fixed interface among user interfaces in the image.

As an example, the variable interface and the fixed interface may be at least any one of a user interface or a graph user interface.

Herein, the mobile device 20 including the vehicle, the robot, and the like may include a camera 22 for capturing an external environment, a vision controller 24 for recognizing an object in the image obtained from the camera 22 and a movement direction of the object, and a communication device 26 for transmitting the image obtained from the camera 22.

The apparatus 10 for processing the user interface in the present disclosure may include a reception device 100 for receiving an image from the mobile device 20 including the vehicle, the robot, and the like, a display device 200 for displaying the image, and a controller 300 for processing a variable interface and a fixed interface among user interfaces in the image. The reception device 100, the display device 200, and the controller 300 may each include a processor, a memory, and communication circuitry.

Herein, the display device 200 may include an image display device 210 including a display panel for outputting an image and a touch input device 220 including a touch panel to which the touch of a user is input.

In some cases, the apparatus 10 for processing the user interface in the present disclosure may further include a calculation device 400 for calculating display information of the user interface based on coordinate information of the object in the image and coordinate information of the touch. The calculation device 400 may include a processor, a memory, and communication circuitry.

Herein, the controller 300 may obtain the coordinate information of the object in the image and the coordinate information of the touch and may provide the calculation device 400 with the obtained coordinate information of the object and the obtained coordinate information of the touch.

Furthermore, the controller 300 may control the display device 200 to display the variable interface around the object in the image based on the calculated result of the calculation device 400.

The controller 300 may control the display device 200 to display the variable interface around the object, when user interaction touching the object in the image is checked, may control the display device 200 to move and re-display the variable interface around the moved object, when the object in the image moves, and may process the variable interface not to overlap with the fixed interface, when the variable interface overlaps with the fixed interface as the object moves.

Herein, when checking the user interaction, the controller 300 may recognize the object in the image and may check whether the user interaction is associated with the recognized object.

In other words, when checking the user interaction, the controller 300 may check that the user interaction is associated with the recognized object, when the user interaction is a user touch input for touching the recognized object, and may check that the user interaction is not associated with the recognized object, when the user interaction is not the user touch input for touching the recognized object.

The controller 300 may control the display device 200 to display the variable interface around the object, when checking that the user interaction is associated with the recognized object, and may process the user interaction as general interaction, when checking that the user interaction is not associated with the recognized object.

Next, the controller 300 may generate the variable interface for the object associated with the user interaction, when displaying the variable interface, and may control the display device 200 to display the variable interface around the object based on the coordinate information of the object.

Herein, the controller 300 may obtain the coordinate information of the object in the image and the coordinate information of the touch, may provide the calculation device 400 with the obtained coordinate information of the object and the obtained coordinate information of the touch, and may control the display device 200 to display the variable interface around the object based on the calculated result of the calculation device 400.

Furthermore, the controller 300 may update the variable interface in real time in response to the coordinate information of the object.

Next, the controller 300 may obtain coordinate information of the moved object, when the object in the image moves, may provide the calculation device 400 with the obtained coordinate information of the object, and may control the display device 200 to re-display the variable interface around the moved object based on the calculated result of the calculation device 400.

Herein, the controller 300 may check whether the fixed interface is located in a movement direction of the variable interface based on the calculated result of the calculation device 400 and may check whether the variable interface overlaps with the fixed interface, when the fixed interface is located in the movement direction of the variable interface.

In other words, the controller 300 may compare coordinates of one corner of the variable interface re-displayed based on the calculated result of the calculation device 400 with coordinates of one corner of the previously displayed variable interface to predict a movement direction of the variable interface, when checking the location of the fixed interface, and may predict whether the fixed interface is located in the predicted movement direction of the variable interface.

The controller 300 may recognize that the variable interface overlaps with the fixed interface when coordinates of an edge endpoint of the variable interface, which are located in the movement direction of the variable interface, are included within the range of coordinates of an edge endpoint of the fixed interface, when checking the overlap between the variable interface and the fixed interface.

Furthermore, when the fixed interface is not located in the movement direction of the object or the variable interface does not overlap with the fixed interface, the controller 300 may control the display device 200 to re-display the variable interface around the moved object based on the calculated result of the calculation device 400.

Next, when processing the variable interface not to overlap, the controller 300 may process the variable interface not to overlap with the fixed interface at a time point when the variable interface starts to overlap with the fixed interface as the object moves.

As an embodiment, when processing the variable interface not to overlap, the controller 300 may control the display device 200 to display a combined interface in which the variable interface and the fixed interface are combined with each other, and may process the variable interface, such that the variable interface and the fixed interface do not overlap with each other.

Herein, the controller 300 may check whether there is a need to divide the combined interface as the object moves, after displaying the combined interface, and may control the display device 200 to divide and display the combined interface into the fixed interface and the variable interface, when there is the need to divide the combined interface, and may control the display device 200 not to display the variable interface corresponding to the object, when the object is out of the image.

Furthermore, the controller 300 may recognize that the variable interface does not overlap with the fixed interface when the coordinates of the edge endpoint are out of the range of the coordinates of the edge endpoint of the fixed interface, when checking whether there is the need to divide the combined interface, and may check that there is the need to divide the combined interface.

Furthermore, the controller 300 may check whether a portion of the object starts to be out of the image, when dividing and displaying the combined interface into the fixed interface and the variable interface, and may control the display device 200 to change and display the variable interface to a horizontal or vertical shape on a screen border region of the image, when the portion of the object starts to be out of the image.

Furthermore, the controller 300 may calculate a masking area of the object, when dividing and displaying the combined interface into the fixed interface and the variable interface, and may control the display device 200 to overlap and display the variable interface with the masking region of the object, which remains in the image, when a certain ratio of the masking area of the object is out of the image.

For example, when about 50% to about 99% of the masking area of the object is out of the image, the controller 300 may control the display device 200 to overlap and display the variable interface with the portion of the masking region of the object that remains in the image.

As another embodiment, the controller 300 may select a position where the variable interface does not overlap with the fixed interface in a surrounding region of the object, when processing the variable interface not to overlap, and may control the display device 200 to move and display the variable interface from the current position to the selected position, thus processing the variable interface, such that the variable interface and the fixed interface do overlap with each other.

As another embodiment, when processing the variable interface not to overlap, the controller 300 may control the display device 200 to remove the fixed interface from the image at a time point when the variable interface starts to overlap with the fixed interface not to display the fixed interface, thus processing the variable interface, such that the variable interface and the fixed interface do not overlap with each other.

Herein, the controller 300 may control the display device 200 not to display the variable interface corresponding to the object, when the object is out of the image, after removing the fixed interface, and simultaneously re-display the removed fixed interface.

As such, the present technology may predict the overlap between the variable interface and the fixed interface based on calculating the coordinates of the variable interface which moves as the object in the image moves and may process the variable interface not to overlap with the fixed interface, thus removing an overlap phenomenon between the variable interface and the fixed interface to improve user convenience and increasing intuition of manipulation to visually naturally improve perceived quality.

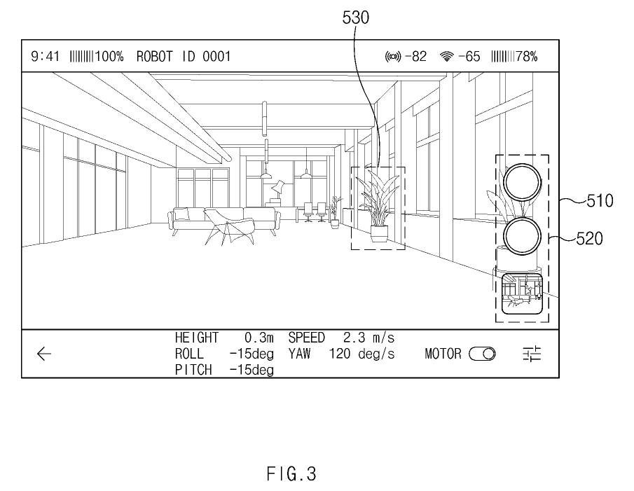

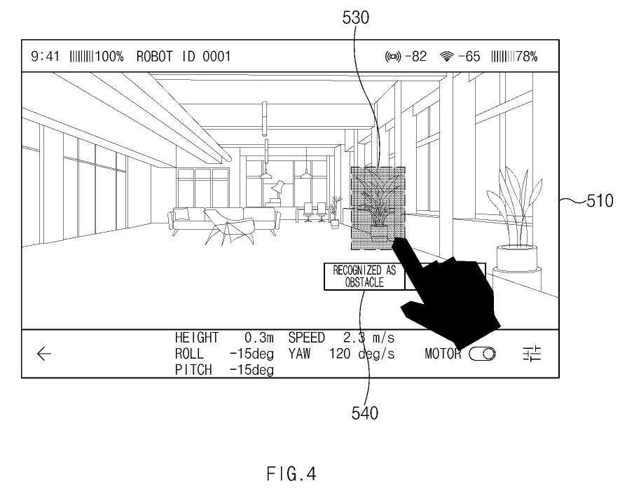

FIG. 3 is a drawing for describing an object and a fixed interface in an image according to an embodiment of the present disclosure. FIG. 4 is a drawing for describing an object and a variable interface in an image according to an embodiment of the present disclosure.

As shown in FIG. 3, the present disclosure may receive a camera streaming image 510 from a mobile device including a vehicle, a robot, and the like.

Herein, the camera streaming image 510 may include various objects 530, such as a flowerpot, and may include various fixed interfaces 520 for user manipulation.

The objects 530 included in the camera streaming image 510 may call and operate some functions via a user input by a user touch, thus increasing intuition of manipulation and use convenience to the user.

As shown in FIG. 4, when receiving a user input for selecting the flowerpot among the various objects 530 in the camera streaming image 510, the present disclosure may display a variable interface 540 capable of calling some functions around the object 530 corresponding to the flowerpot.

As an example, as the user drags and masks the object 530 corresponding to the flowerpot, the present disclosure may display the variable interface 540 at a point where the user touch is detached.

Herein, the variable interface 540 may interwork with the movement of the object 530 to move together as the camera view moves and may disappear together with the object 530 to an outer region of the camera view.

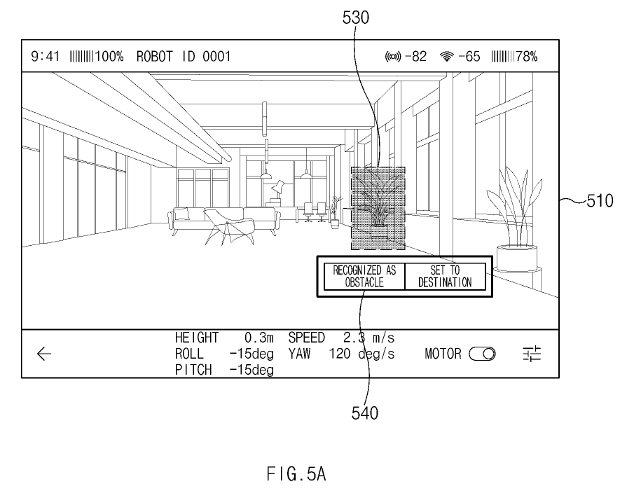

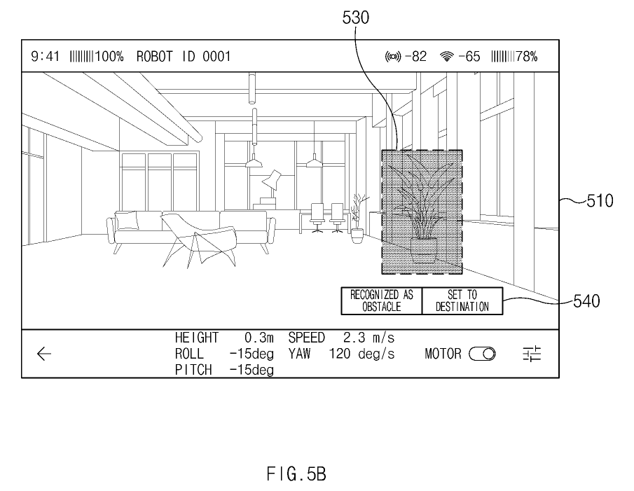

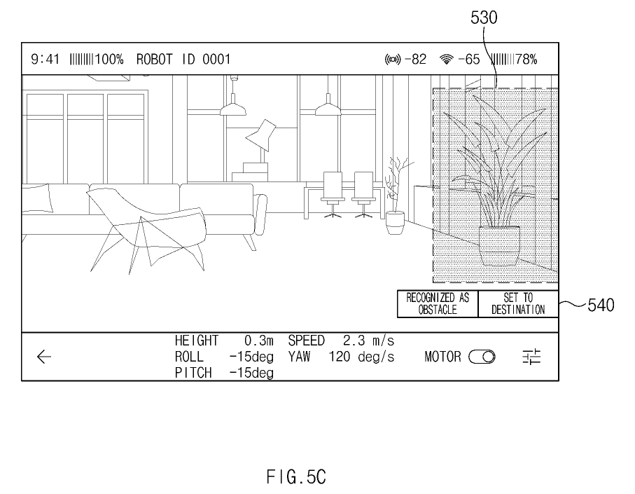

FIG. 5A is a drawing for illustrating a screen displaying a variable interface around an object according to an embodiment of the present disclosure, FIG. 5B is a drawing for illustrating a screen that re-displays the variable interface based on the movement of the object according to an embodiment of the present disclosure, FIG. 5C is a drawing for illustrating a screen that updates size and position of the variable interface according to an embodiment of the present disclosure.

As shown in FIG. 5A, when receiving a user touch input for selecting an object 530 in a camera streaming image 510, the present disclosure may obtain coordinate information of the object 530 in the image 510 and coordinate information of the touch and may display a variable interface 540 around the object 530 based on the calculated result of the obtained coordinate information of the object 530 and the obtained coordinate information of the touch.

Herein, the present disclosure may update the variable interface 540 in real time in response to the coordinate information of the object 530.

Next, as shown in FIG. 5B, when the object 530 in the camera streaming image 510 moves, the present disclosure may obtain coordinate information of the moved object 530, may calculate the obtained coordinate information of the object 530, and may move and re-display the variable interface 540 around the moved object 530 based on the calculated result.

As an example, when the camera mounted on a mobile device closely approaches the object 530, because the object 530 in the image increases in size and varies in position, the present disclosure may update and display the variable interface 540 to vary in size and position in response to it.

Next, as shown in FIG. 5C, when the camera mounted on (located in) the mobile device approaches the object 530 to pass through it, because the object 530 in the image increases in size, varies in position, and is out of the image, the present disclosure may update the variable interface 540 to be vary in size and position in response to it and disappear together when the object 530 disappears from the image.

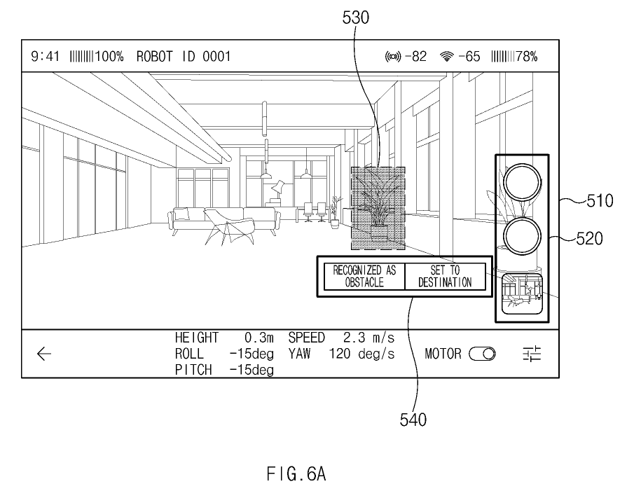

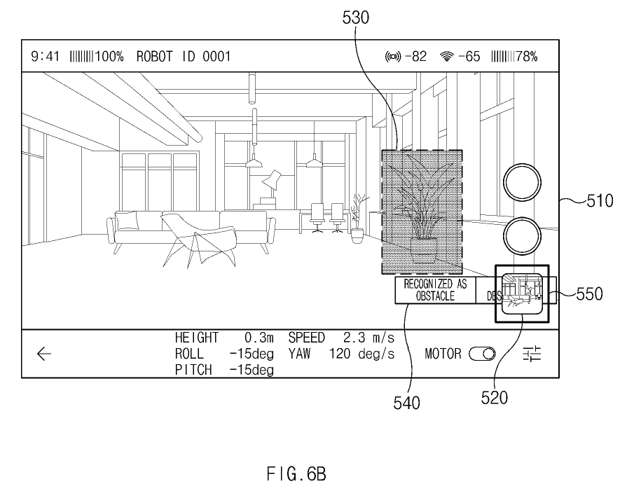

FIG. 6A is a drawing for illustrating a screen displaying a variable interface and a fixed interface in an image according to an embodiment of the present disclosure, FIG. 6B is a drawing for describing an overlap between a variable interface and a fixed interface in an image according to an embodiment of the present disclosure.

As shown in FIG. 6A, when an object 530 in a camera streaming image 510 in which a fixed interface 520 is located in a certain region moves, the present disclosure may obtain coordinate information of the moved object 530, may calculate the obtained coordinate information of the object 530, and may move and display the variable interface 540 around the moved object 530 based on the calculated result.

Next, as shown in FIG. 6B, when the fixed interface 520 is located in a movement direction of the variable interface 540, an overlap region 550 where the variable interface 540 and the fixed interface 520 overlap with each other may occur as the object 530 in the camera streaming image 510 moves.

Herein, in the overlap region 550, when the variable interface 540 is displayed on a lower layer and the fixed interface 520 is displayed on an upper layer, there may occur a situation in which a user is unable to manipulate the variable interface 540 located on the lower layer.

Thus, when the variable interface 540 overlaps with the fixed interface 520 as the object 530 moves, the present disclosure may process the variable interface 540 not to overlap with the fixed interface 520.

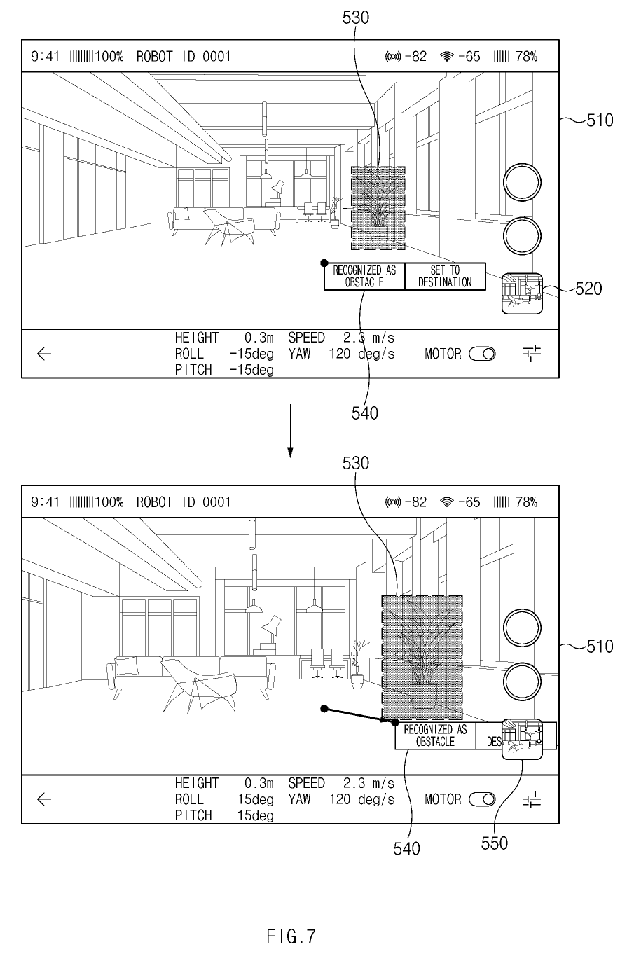

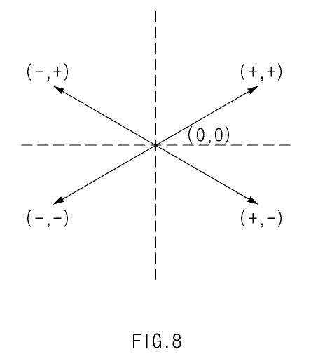

FIG. 7 is a drawing for describing a process of determining a movement direction of a variable interface in an image according to an embodiment of the present disclosure. FIG. 8 is a drawing for illustrating a quadrant coordinate system according to an embodiment of the present disclosure.

As shown in FIG. 7, when an object 530 in a camera streaming image moves, the present disclosure may obtain coordinate information of the moved object 530, may calculate the obtained coordinate information of the object 530, may move and display the variable interface 540 together around the moved object 530 based on the calculated result, may check whether the fixed interface 520 is located in a movement direction of the variable interface 540, and may predict that the variable interface 540 overlaps with the fixed interface 520, when the fixed interface 520 is located in the movement direction of the variable interface 540.

In other words, the present disclosure may compare coordinates of one corner of the variable interface 540 with coordinates of one corner of the previously displayed variable interface 540 to predict the movement direction of the variable interface 540 and may predict whether the fixed interface 520 is located in the predicted movement direction of the variable interface 540.

For example, whenever the camera mounted on a mobile device moves, because an object in a camera image also moves, the present disclosure may move and display the variable interface 540 in response to it.

Herein, the present disclosure may use coordinates of one corner of the variable interface 540, for example, an upper left corner as a representative point to predict movement directionality based on a difference between coordinates immediately before the point and newly moved coordinates and may check whether the fixed interface 520 is located in the movement directionality.

As shown in FIG. 7, the present disclosure may predict that coordinates of a point corresponding to the upper left corner of the variable interface 540 have the directionality of (+, -) to move and may check that the fixed interface 520 is located in the directionality of (+, -).

As shown in FIG. 8, the variable interface 540 of the present disclosure may have any one of the directionalities of (-, +), (+, +), (-, -), and (+, -) based on a quadrant coordinate system indicating directionality.

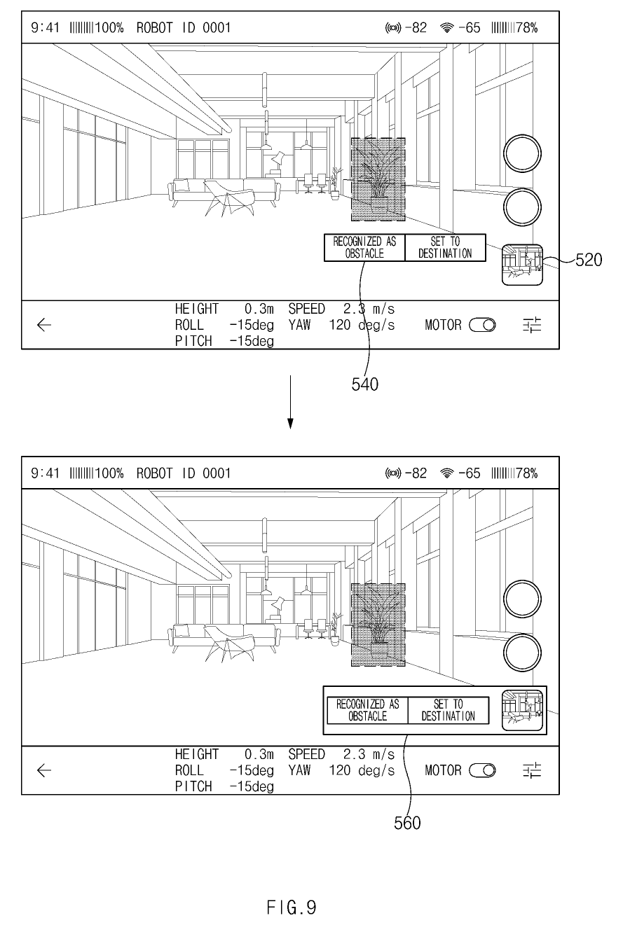

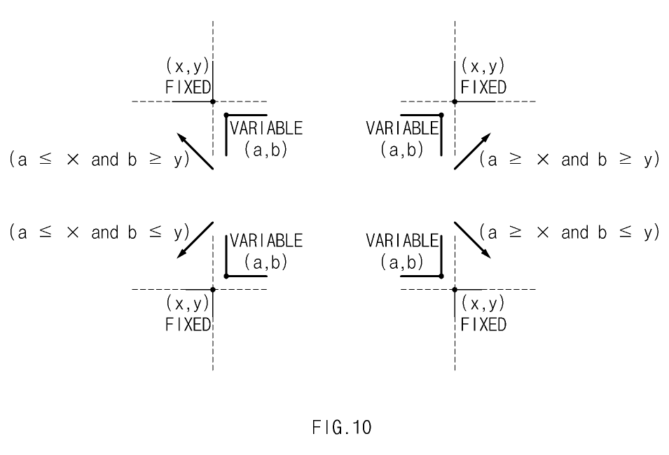

FIG. 9 is a drawing for describing a process of processing the variable interface not overlap with the fixed interface according to an embodiment of the present disclosure. FIG. 10 is a drawing for a drawing for describing a process of determining an overlap between a variable interface and a fixed interface in an image according to an embodiment of the present disclosure.

As shown in FIG. 9, when coordinates of an edge endpoint of a variable interface 540, which are located in the movement direction of the variable interface 540, are included within the range of coordinates of an edge endpoint of a fixed interface 520, the present disclosure may recognize that the variable interface 540 overlap with the fixed interface 520.

The present disclosure may process the variable interface 540 not to overlap with the fixed interface 520 at a time point when the variable interface 540 starts to overlap with the fixed interface 520 as an object moves.

As an embodiment, the present disclosure may display a combined interface 560 in which the variable interface 540 and the fixed interface 520 are combined with each other and may process the variable interface 540, such that the variable interface 540 and the fixed interface 520 do not overlap with each other.

When recognizing the directionality of the variable interface 540 and the fixed interface 520 located in the corresponding direction, the present disclosure may determine the moment when the two interfaces 520 and 540 are initially adjacent to each other.

As shown in FIG. 10, the present disclosure may determine whether coordinates (a, b) of one endpoint of the variable interface 540 enter the range of coordinates (x, y) of one endpoint of the fixed interface depending on the movement directionality.

At this time, each endpoint may vary with the movement directionality, as shown in FIG. 10.

As an example, the endpoint may vary with a shape of the interface, such as a quadrangle, a circle, or a polygon. However, a UI/GUI calculation device may calculate a final endpoint for each movement directionality.

The present disclosure may determine that the two interfaces 520 and 540 overlap with each other at the moment when the coordinates (a, b) of the one endpoint of the variable interface 540 enter the range of the coordinates (x, y) of the endpoint of the fixed interface 520 to overlap with each other and may generate and display an animation, such as the combined interface 560 in which the variable interface 540 and the fixed interface 520 are combined with each other.

In other words, as shown in FIG. 10, when meeting an AND condition in which the coordinates (a, b) of the one endpoint of the variable interface 540 enter the range of the coordinates (x, y) of the one endpoint of the fixed interface 520, as an AND condition for determining an overlap when the variable interface 540 moves in each direction of a quarterspace, the present disclosure may determine that the variable interface 540 and the fixed interface 520 overlap with each other.

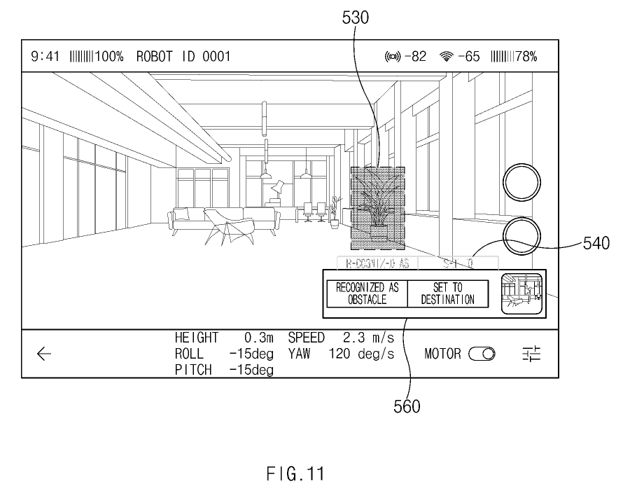

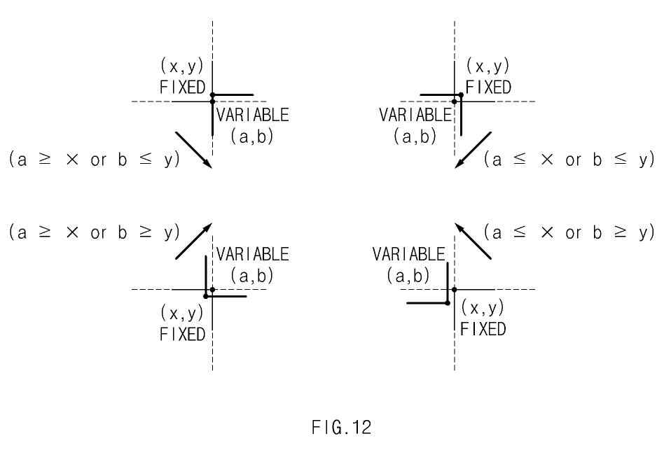

FIG. 11 is a drawing for illustrating a screen displaying a combined interface in an image according to an embodiment of the present disclosure. FIG. 12 is a drawing for describing a process of determining division of a variable interface processed not to overlap and a fixed interface in an image according to an embodiment of the present disclosure.

As shown in FIGS. 11 and 12, after displaying a combined interface 560, the present disclosure may check whether there is a need to divide the combined interface 560 as an object 530 moves and may divide and display the combined interface 560 into a fixed interface and a variable interface, when there is the need to divide the combined interface 560.

Herein, the present disclosure may recognize that the variable interface does not overlap with the fixed interface when coordinates of an edge endpoint of the variable interface is out of the range of coordinates of an edge endpoint of the fixed interface, when checking whether there is the need to divide the combined interface 560, and may check that there is the need to divide the combined interface 560.

When there occurs a situation or the like in which a mobile device moves oppositely, there may be a case in which the present disclosure should divide and display the combined interface 560 again.

To this end, even in the situation in which the present disclosure displays the combined interface 560, a calculation device may continuously calculate a coordinate position of the variable interface and a coordinate position of the fixed interface in the background, as before.

Herein, as shown in FIG. 12, the present disclosure may determine the moment when coordinate a or b of one endpoint of the variable interface is separated from coordinate x or y of one endpoint of the fixed interface as opposed to the combination depending on each directionality as a time point when there is a need to divide a combined interface.

In other words, as shown in FIG. 12, when any one of coordinate a or b of the variable interface is separated from coordinate x or y of the fixed interface, as an OR condition for determining division when the variable interface moves in each direction of a quarterspace, the present disclosure may determine a time point when the combined interface is divided.

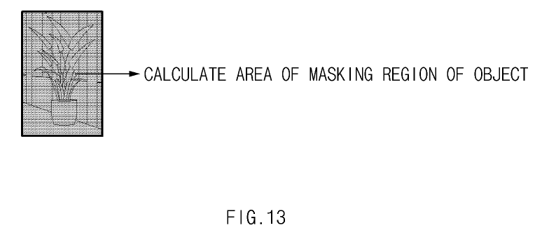

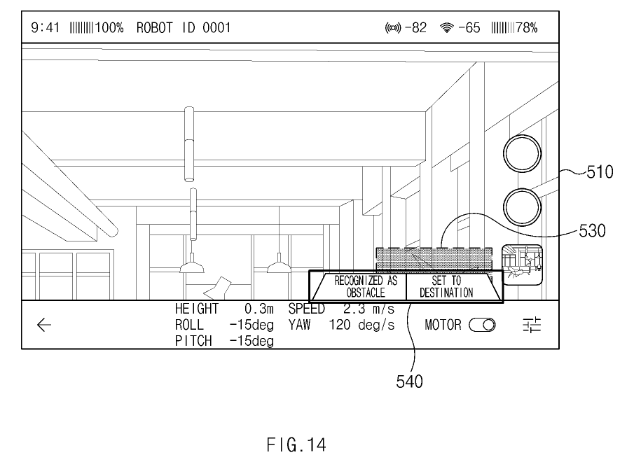

FIG. 13 is a drawing for describing a process of calculating a masking area of an object according to an embodiment of the present disclosure. FIG. 14 is a drawing for describing a process of processing a variable interface, when a portion of an object is out of an image, according to an embodiment of the present disclosure.

As shown in FIGS. 13 and 14, the present disclosure may check whether a portion of an object 530 starts to be out of an image and may change and display a variable interface 540 to a horizontal or vertical shape on a screen border region of the image, when the portion of the object 530 starts to be out of the image.

The present disclosure may calculate a masking area of the object 530, as shown in FIG. 13, and may overlap and display the variable interface 540 with the masking region of the object 530, which remains in the image, when a certain ratio of the masking area of the object 530 is out of the image.

The present disclosure may calculate an area of a region where the object 530 is masked, when the previously recognized object 530 is out of the screen as a mobile device moves, and may overlap the variable interface 540 on masking of the object 530, when the certain ratio of the area is out of the screen, and may attach and display the variable interface 540 to an upper/lower/left/right border of the region out of the screen.

For example, when about 50% to about 99% of the masking area of the object 530 are out of the image, the controller 300 may overlap and display the variable interface 540 with the masking region of the object 530, which remains in the image.

As such, the reason why the variable interface 540 is attached to the border of the screen is to more interactively show that the object 530 disappears out of the screen region.

Furthermore, when the object 530 is completely out of the image, the present disclosure may remove the variable interface 540 corresponding to the object 530 from the image not to be displayed.

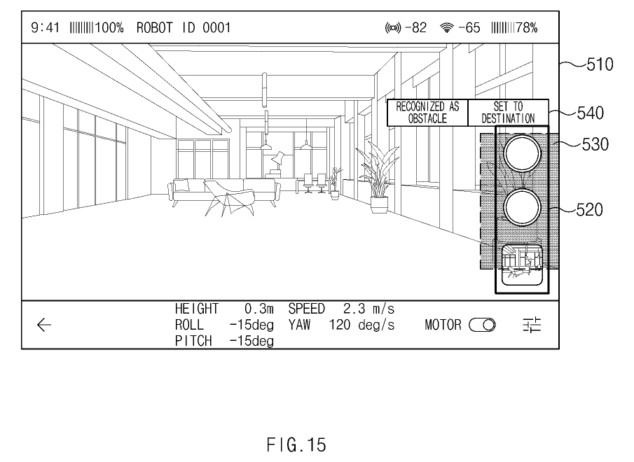

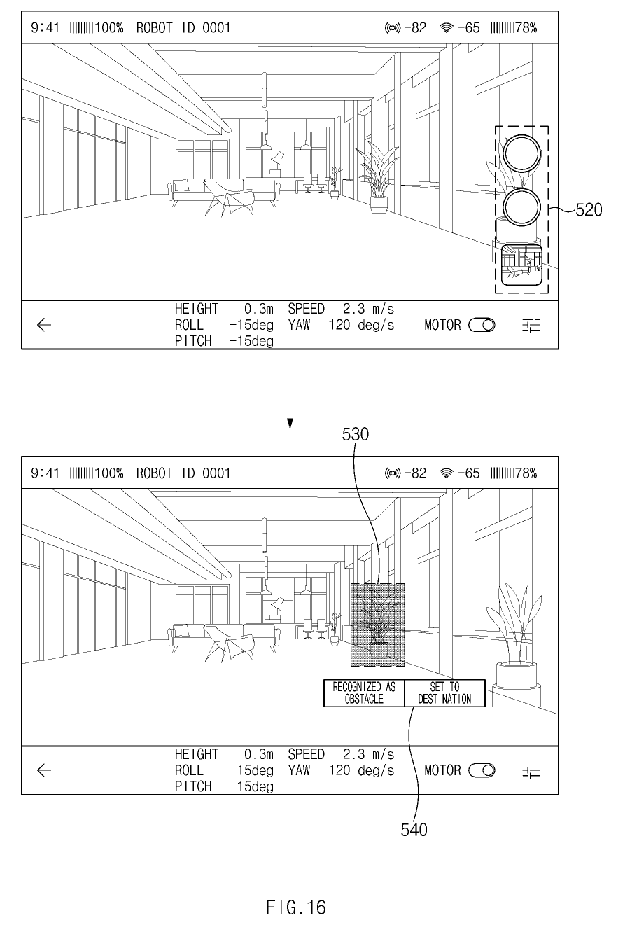

FIG. 15 is a drawing for describing a process of processing a variable interface and a fixed interface in an image not to overlap with each other according to another embodiment of the present disclosure. FIG. 16 is a drawing for describing a process of processing a variable interface and a fixed interface in an image not to overlap with each other according to another embodiment of the present disclosure.

As shown in FIG. 15, as another embodiment, the present disclosure may select a position where a variable interface 540 does not overlap with a fixed interface 520 in a surrounding region of an object 530, when processing the variable interface 540 not to overlap and may move and display the variable interface 540 from the current position to the selected position on the selected position, thus processing the variable interface 540, such that the variable interface 540 and the fixed interface 520 do not overlap with each other.

As another embodiment, as shown in FIG. 16, the present disclosure may remove the fixed interface 520 from the image not to display the fixed interface 520 at a time point when the variable interface 540 starts to overlap with the fixed interface 520, when processing the variable interface 540 not to overlap, thus processing the variable interface 540, such that the variable interface 540 and the fixed interface 520 do not overlap with each other.

Herein, after removing the fixed interface 520, when the object 530 is out of the image, the present disclosure may not display the variable interface 540 corresponding to the object 530 and may simultaneously re-display the removed fixed interface 520.

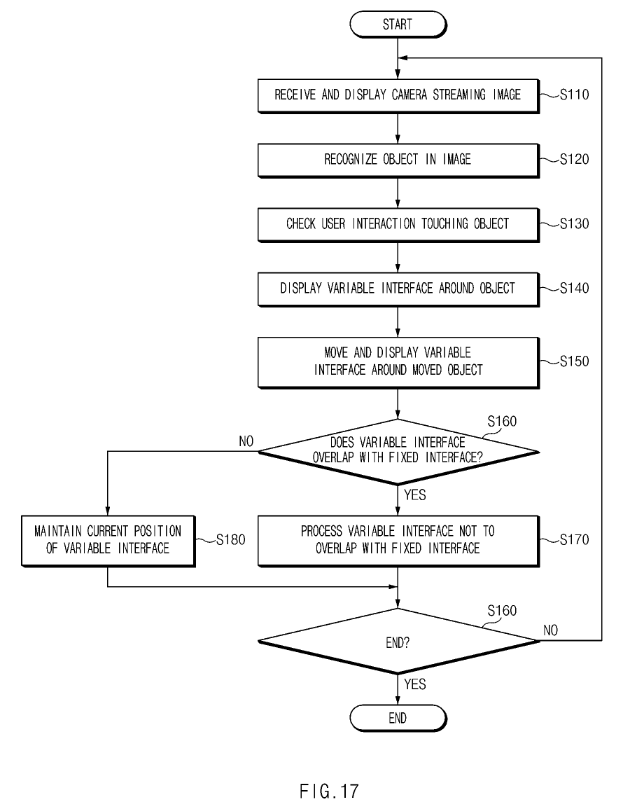

FIG. 17 is a flowchart for describing a method for processing a user interface in an image according to an embodiment of the present disclosure.

As shown in FIG. 17, in S110, the present disclosure may receive and display a camera streaming image from an external mobile device.

In S120, the present disclosure may recognize an object in the image. In S130, the present disclosure may check user interaction touching the object in the image.

Next, in S140, the present disclosure may display a variable interface around the object in response to the user interaction.

Next, when the object in the image moves, in S150, the present disclosure may move and display the variable interface around the moved object.

Herein, the present disclosure may obtain coordinate information of the object in the image and coordinate information of the touch, may calculate display coordinates of the variable interface based on the obtained coordinate information of the object and the obtained coordinate information of the touch, and may display the variable interface around the object based on the calculated result.

In S160, the present disclosure may check whether the variable interface overlaps with the fixed interface as the object moves.

Herein, the controller 300 may check whether the fixed interface is located in a movement direction of the variable interface and may check whether the variable interface overlaps with the fixed interface, when the fixed interface is located in the movement direction of the variable interface.

In other words, the present disclosure may compare coordinates of one corner of the currently displayed variable interface with coordinates of one corner of the previously displayed variable interface to predict the movement direction of the variable interface and may predict to check whether the fixed interface is located in the predicted movement direction of the variable interface.

Next, when the variable interface and the fixed interface overlap with each other, in S170, the present disclosure may process the variable interface not to overlap with the fixed interface. When the variable interface and the fixed interface do not overlap with each other, in S180, the present disclosure may maintain the current position of the variable interface.

Herein, the present disclosure may process the variable interface not to overlap with the fixed interface at a time point when the variable interface starts to overlap with the fixed interface as the object moves.

As an example, the present disclosure may generate a combined interface in which the variable interface and the fixed interface are combined with each other at a time point when the variable interface starts to overlap with the fixed interface and may process the variable interface, such that the variable interface and the fixed interface do not overlap with each other.

Herein, the controller 300 may check whether there is a need to divide the combined interface as the object moves, after displaying the combined interface, may divide and display the combined interface into the fixed interface and the variable interface, when there is the need to divide the combined interface, and may remove the variable interface corresponding to the object not to display the variable interface, when the object is out of the image.

At this time, the present disclosure may check whether a portion of the object starts to be out of the image and may change and display the variable interface to a horizontal or vertical shape on a screen border region of the image, when the portion of the object is out of the image.

Furthermore, the present disclosure may calculate a masking area of the object and may overlap and display the variable interface with an object region which remains in the image, when a certain ratio of the masking area of the object is out of the image.

As another embodiment, the present disclosure may select a position where the variable interface does not overlap with the fixed interface in a surrounding region of the object and may move the variable interface from the current position to the selected position to display the variable interface on the selected position, thus processing the variable interface, such that the variable interface and the fixed interface do overlap with each other.

As an example, the present disclosure may remove the fixed interface from the image at a time point when the variable interface starts to overlap with the fixed interface and may process the variable interface, such that the variable interface and the fixed interface do not overlap with each other.

Herein, after removing the fixed interface, when the object is out of the image, the present disclosure may not display the variable interface corresponding to the object and may simultaneously re-display the removed fixed interface.

In S190, the present disclosure may check whether displaying the image ends. When displaying the image ends, the present disclosure may end displaying the image and processing the user interface.

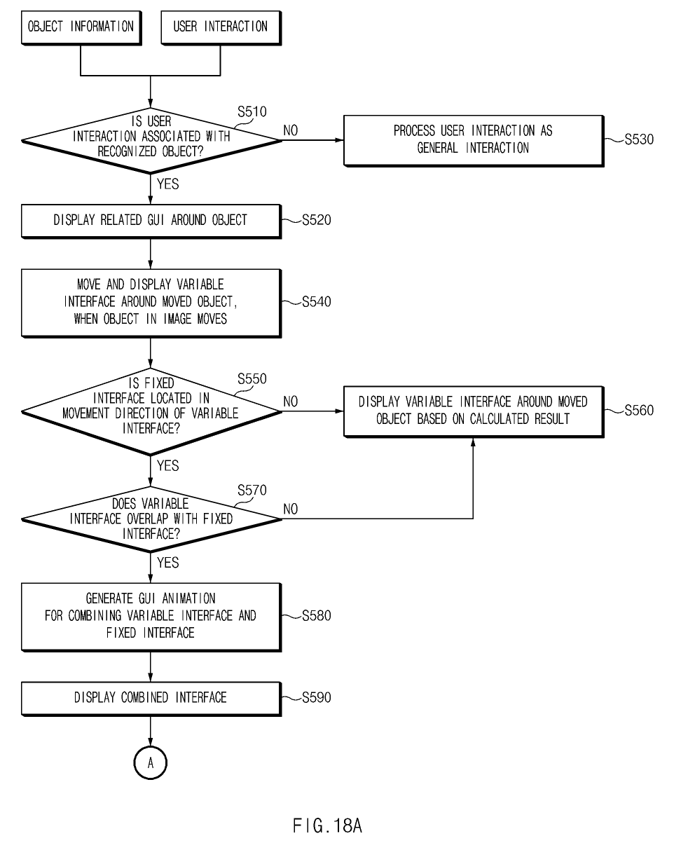

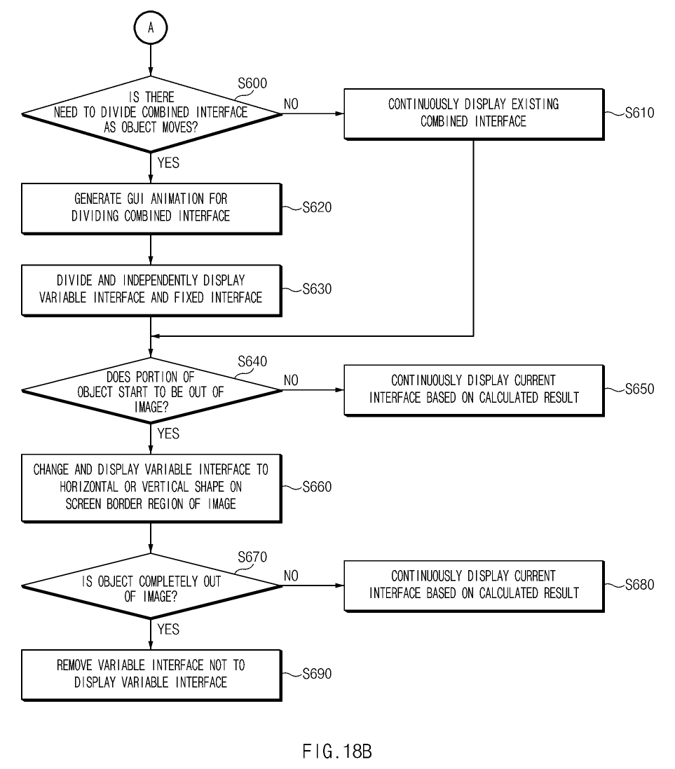

FIGS. 18A and 18B are flowcharts for describing a method for processing a variable interface such that the variable interface and a fixed interface do not overlap with each other via a combined interface.

As shown in FIGS. 18A and 18B, in S510, the present disclosure may recognize an object in an image and may check whether user interaction is associated with the recognized object.

In other words, the present disclosure may check that the user interaction is associated with the recognized object, when the user interaction is a user touch input for touching the recognized object, and may check that the user interaction is not associated with the recognized object, when the user interaction is not the user touch input for touching the recognized object.

Next, when checking that the user interaction is associated with the recognized object, in S520, the present disclosure may display a variable interface, such as a GUI, around the object.

Furthermore, when checking that the user interaction is not associated with the recognized object, in S530, the present disclosure may process the user interaction as general interaction.

Next, in S540, the present disclosure may move and display the variable interface around the moved object, when the object in the image moves.

Herein, the present disclosure may obtain coordinate information of the moved object, when the object in the image moves, may provide a calculation device with the obtained coordinate information of the object, and may move and display the variable interface around the moved object based on the calculated result of the calculation device.

In S550, the present disclosure may check whether the fixed interface is located in a movement direction of the variable interface based on the calculated result of the calculation device.

Herein, the present disclosure may compare coordinates of one corner of the currently displayed variable interface with coordinates of one corner of the previously displayed variable interface to predict the movement direction of the variable interface based on the calculated result of the calculation device and may predict to check whether the fixed interface is located in the predicted movement direction of the variable interface.

Next, when the fixed interface is located in the movement direction of the variable interface, in S570, the present disclosure may check whether the variable interface overlaps with the fixed interface.

Herein, when coordinates of an edge endpoint of the variable interface, which are located in the movement direction of the variable interface, are included within the range of coordinates of an edge endpoint of the fixed interface, the present disclosure may recognize that the variable interface overlaps with the fixed interface.

Furthermore, when the fixed interface is not located in the movement direction of the object or the variable interface does not overlap with the fixed interface, in S560, the present disclosure may display the variable interface around the moved object based on the calculated result of the calculation device.

Next, when the variable interface overlaps with the fixed interface as the object moves, in S580 and S590, the present disclosure may generate a GUI animation for combining the variable interface and the fixed interface at a time point when the variable interface starts to overlap with the fixed interface and may display a combined interface.

In S600, the present disclosure may check whether there is a need to divide the combined interface as the object moves.

Herein, the present disclosure may recognize that the variable interface does not overlap with the fixed interface, when coordinates of an edge endpoint of the variable interface are out of the range of coordinates of an edge endpoint of the fixed interface, and may check that there is the need to divide the combined interface.

Next, when there is no need to divide the combined interface, in S610, the present disclosure may continuously display an existing combined interface. When there is the need to divide the combined interface, in S620 and S630, the present disclosure may generate a GUI animation for dividing the combined interface into the fixed interface and the variable interface and may divide and independently display the variable interface and the fixed interface.

Next, in S640, the present disclosure may check whether a portion of the object starts to be out of the image.

When the portion of the object is not out of the image, in S650, the present disclosure may continuously display the current interface based on the calculated result of the calculation device. When the portion of the object starts to be out of the image, in S660, the present disclosure may change and display the variable interface to a horizontal or vertical shape on a screen border region of the image.

Herein, the present disclosure may calculate a masking area of the object and may overlap and display the variable interface with an object region which remains in the image, when a certain ratio of the masking area of the object is out of the image.

Next, in S670, the present disclosure may check whether the object is completely out of the image.

Next, when the object is not completely out of the image, in S680, the present disclosure may continuously display the current interface based on the calculated result of the calculation device. When the object is completely out of the image, in S690, the present disclosure may remove the variable interface corresponding to the object not to display the variable interface.

As such, the present technology may predict the overlap between the variable interface and the fixed interface based on calculating the coordinates of the variable interface which moves as the object in the image moves and may process the variable interface not to overlap with the fixed interface, thus removing an overlap phenomenon between the variable interface and the fixed interface to improve user convenience and increasing intuition of manipulation to visually naturally improve perceived quality.

The present technology may predict an overlap between a variable interface and a fixed interface based on calculating coordinates of the variable interface which moves as an object in an image moves and may process the variable interface not to overlap with the fixed interface, thus removing an overlap phenomenon between the variable interface and the fixed interface to improve user convenience and increasing intuition of manipulation to visually naturally improve perceived quality.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for processing a user interface in an image, the apparatus comprising:
a reception device configured to receive the image comprising an object;
a display device configured to display the image comprising the object; and
a controller configured to:
process a variable interface and a fixed interface among user interfaces in the image,
control the display device to display the variable interface around the object in the image, when a user interaction touch of the object is determined;
control the display device to move and re-display the variable interface around the object, when the object in the image moves; and
process the variable interface not to overlap with the fixed interface, when the variable interface overlaps with the fixed interface as the object moves.

2. The apparatus of claim 1, further comprising:
a calculation device configured to calculate display information of the user interface based on first coordinate information of the object in the image and second coordinate information of the user interaction touch to obtain a calculated result,
wherein the controller is further configured to:
control the display device to display the variable interface around the object based on the calculated result.

3. The apparatus of claim 1, wherein the controller is further configured to:
process the variable interface not to overlap with the fixed interface at a time point when the variable interface starts to overlap with the fixed interface as the object moves, when processing the variable interface not to overlap with the fixed interface.

4. The apparatus of claim 3, wherein the controller is further configured to:
control the display device to display a combined interface in which the variable interface and the fixed interface are combined with each other, when processing the variable interface not to overlap with the fixed interface; and
process the variable interface, such that the variable interface and the fixed interface do not overlap with each other.

5. The apparatus of claim 4, wherein the controller is further configured to:
check whether there is a need to divide the combined interface as the object moves, after displaying the combined interface;
control the display device to divide and display the combined interface into the fixed interface and the variable interface, when there is the need to divide the combined interface; and
control the display device not to display the variable interface corresponding to the object, when the object is out of the image.

6. The apparatus of claim 5, wherein the controller is further configured to:
check whether a portion of the image starts to be out of the image, when dividing and displaying the combined interface into the fixed interface and the variable interface; and
control the display device to change and display the variable interface to a horizontal or vertical shape on a screen border region of the image, when the portion of the object starts to be out of the image.

7. The apparatus of claim 5, wherein the controller is further configured to:
calculate a masking area of the object, when dividing and displaying the combined interface into the fixed interface and the variable interface; and
control the display device to overlap and display the variable interface with a masking region of the object, the masking region remaining in the image, when a certain ratio of the masking area of the object is out of the image.

8. The apparatus of claim 3, wherein the controller is further configured to:
select a position where the variable interface does not overlap with the fixed interface in a surrounding region of the object, when processing the variable interface not to overlap with the fixed interface;
control the display device to move and display the variable interface from a current position to the selected position; and
process the variable interface, such that the variable interface and the fixed interface do not overlap with each other.

9. The apparatus of claim 3, wherein the controller is further configured to:
control the display device to remove the fixed interface from the image to not display the fixed interface at the time point when the variable interface starts to overlap with the fixed interface, when processing the variable interface not to overlap with the fixed interface; and
process the variable interface, such that the variable interface and the fixed interface do not overlap with each other.

10. The apparatus of claim 9, wherein the controller is further configured to:
control the display device not to display the variable interface corresponding to the object, when the object is out of the image, after removing the fixed interface; and
simultaneously re-display the removed fixed interface.

11. A user interface processing method of a user interface processing apparatus for processing a variable interface and a fixed interface among user interfaces in an image, the user interface processing method comprising:
determining a user interaction touch of an object in the image;
displaying the variable interface around the object in response to the user interaction touch;
moving and re-displaying the variable interface around the object, when the object in the image moves;
checking whether the variable interface overlaps with the fixed interface as the object moves; and
processing the variable interface not to overlap with the fixed interface, when the variable interface and the fixed interface overlap with each other.

12. The user interface processing method of claim 11, wherein the displaying of the variable interface includes:
obtaining first coordinate information of the object in the image and second coordinate information of the user interaction touch;
calculating display coordinates of the variable interface based on the first coordinate information of the object and the second coordinate information of the touch to obtain a calculated result; and
displaying the variable interface around the object based on the calculated result.

13. The user interface processing method of claim 11, wherein the processing of the variable interface not to overlap includes:
processing the variable interface not to overlap with the fixed interface at a time point when the variable interface starts to overlap with the fixed interface as the object moves.

14. The user interface processing method of claim 13, wherein the processing of the variable interface not to overlap includes:
generating a combined interface in which the variable interface and the fixed interface are combined with each other at the time point when the variable interface starts to overlap with the fixed interface; and
processing the variable interface, such that the variable interface and the fixed interface do not overlap with each other.

15. The user interface processing method of claim 14, wherein the processing of the variable interface not to overlap includes:
checking whether there is a need to divide the combined interface as the object moves, after displaying the combined interface;
dividing and displaying the combined interface into the fixed interface and the variable interface, when there is the need to divide the combined interface; and
removing the variable interface corresponding to the object to not display the variable interface, when the object is out of the image.

16. The user interface processing method of claim 15, wherein the dividing and displaying into the fixed interface and the variable interface includes:
checking whether a portion of the image starts to be out of the image; and
changing and displaying the variable interface to a horizontal or vertical shape on a screen border region of the image, when the portion of the object starts to be out of the image.

17. The user interface processing method of claim 15, wherein the dividing and displaying into the fixed interface and the variable interface includes:
calculating a masking area of the object; and
overlapping and displaying the variable interface with a masking region of the object, the masking region remaining in the image, when a certain ratio of the masking area of the object is out of the image.

18. The user interface processing method of claim 13, wherein the processing of the variable interface not to overlap includes:
selecting a position where the variable interface does not overlap with the fixed interface in a surrounding region of the object;
moving and displaying the variable interface from a current position to the selected position; and
processing the variable interface, such that the variable interface and the fixed interface do not overlap with each other.

19. The user interface processing method of claim 13, wherein the processing of the variable interface not to overlap includes:
removing the fixed interface from the image at the time point when the variable interface starts to overlap with the fixed interface; and
processing the variable interface, such that the variable interface and the fixed interface do not overlap with each other.

20. The user interface processing method of claim 19, wherein the processing of the variable interface not to overlap includes:
not displaying the variable interface corresponding to the object, when the object is out of the image, after removing the fixed interface; and
simultaneously re-displaying the removed fixed interface.
